(19) United States
(12) Patent Application Publication
(10) Pub. No.: US 2004/0008753 A1
(43) Pub. Date: Jan. 15, 2004

(54) Emissivity distribution measuring method and apparatus

(75) Inventors: Miyuki Hashimoto, Ichinomiya-shi (JP); Kenji Yano, Kasugai-shi (JP); Misao Iwata, Nagoya-shi (JP); Kuniyuki Kitagawa, Nagoya-shi (JP)

Correspondence Address: OLIFF & BERRIDGE, PLC, P.O. BOX 19928, ALEXANDRIA, VA, 22320, US

(73) Assignees: NORITAKE CO., LIMITED, Nagoya-shi (JP); Kuniyuki Kitagawa, Nagoya-shi (JP)

(21) Appl. No.: 10/613,072

(22) Filed: Jul. 7, 2003

(30) Foreign Application Priority Data
Jul. 15, 2002 (JP) 2002-205202

(51) Int. Cl. G01K 3/00

(52) U.S. Cl. 374/137

(57) ABSTRACT

Method and apparatus for measuring a distribution of emissivity on a surface of an object body, on the basis of a light emitted from the surface of the object body, wherein a temperature of the object body at each picture element of its image is calculated on the basis of a radiant intensity ratio at each pair of corresponding picture elements of a first image and a second image which are obtained with respective two radiations of respective first and second wavelengths selected from the light emitted from the surface of the object body, to measure a distribution of the temperature on the surface of the object body, and an emissivity value at each picture element of the image of the object body is calculated on the basis of the measured distribution of the temperature, and according to a predetermined relationship between the temperature and the emissivity value.

This application is based on Japanese Patent Application No. 2002-205202 filed Jul. 15, 2002, the contents of which are incorporated hereinto by reference.

### BACKGROUND OF THE INVENTION

1. Field of the Invention

The present invention relates to a method and an apparatus which permit measurement of a distribution of surface temperature of an object made of a plurality of different materials the emissivity values of which are not known, and measurement of a distribution of emissivity on the surface of the object on the basis of the measured distribution of the surface temperature

2. Discussion of Related Art

Radiations emitted from respective local portions of a surface of an object body have different radiant intensity values corresponding to the temperature and emissivity at the respective local portions. To measure the emissivity on the surface of the object body, an intensity I₂ of an infrared radiation having each wavelength emitted from the object body is measured by using an infrared radiation detector such as FT-IR, and an intensity I₁ of an infrared radiation emitted from a black body furnace having the same temperature is measured. Where emissivity ε is represented by a ratio I₂/I₁, namely, a ratio of the intensity I₂ of the infrared radiation of each wavelength emitted from the object body to the intensity I₁ of the infrared radiation of the wavelength emitted from the black body, there is a relationship represented by I₁ε=I₂, so that the emissivity at each wavelength can be calculated according to this relationship. Where an exact distribution of the emissivity of the object body is not known, the distribution of the temperature cannot be accurately obtained, by a non-contact measuring method. In this case, the object body is irradiated at a local portion thereof with an infrared radiation having a known radiant intensity I₃, and an intensity I₄ of an infrared radiation reflected from the irradiated local portion is measured. A reflectivity value ρ of the infrared radiation of the intensity I₄ is obtained according to a known relationship represented by I₄=ρI₃. Since a relationship represented by an equation ε=(1−ρ) is generally satisfied, the emissivity ε can be obtained on the basis of the reflectivity ρ and according to this equation. An example of such a method of obtaining the emissivity is disclosed in JP-A-5-209792.

Where the emissivity of the object body is measured by using an infrared radiation detector such as FT-IR as in the former method described above, the distribution of the emissivity on the surface of the object body cannot be accurately measured when the surface have different emissivity values at respective local portions thereof, or when the emissivity on the surface varies from time to time. Where the emissivity ε is obtained on the basis of the reflectivity ρ as in the latter method described above, an infrared radiation source is required to irradiate the object body with an infrared radiation, and the reflectivity cannot be accurately obtained when a distance between the infrared radiation source and the object body, or the shape or geometry of the object body varies. Further, where the object body is a ceramic material or any other material which is to be heated to a relatively high temperature, the object body must be irradiated with an infrared radiation having a higher radiant intensity than such a ceramic material, and a furnace in which the object body is heated tends to be complicated in construction due to the provision of a window through which the object body is irradiated with the infrared radiation and inspected, so that the furnace tends to suffer from a problem of thermal energy leakage.

### SUMMARY OF THE INVENTION

The present invention was made in view of the background art discussed above. It is a first object of the present invention to provide a method which permits accurate measurement of a distribution of emissivity on a surface of an object body, without using a light source. A second object of the invention is to provide an apparatus suitable for practicing the method.

The first object may be achieved according to a first aspect of this invention, which provides a method of measuring a distribution of emissivity on a surface of an object body, on the basis of a light emitted from the surface of the object body, the method comprising:

a temperature-distribution measuring step of calculating a temperature of the object body at each picture element of its image on the basis of a radiant intensity ratio at each pair of corresponding picture elements of a first image and a second image which are obtained with respective two radiations having respective first and second wavelengths selected from the light emitted from the surface of the object body, for thereby measuring a distribution of the temperature on the surface of the object body; and

an emissivity calculating step of calculating an emissivity value at each picture element of the image of the object body, on the basis of the distribution of the temperature measured in the temperature-distribution measuring step, and according to a predetermined relationship between the temperature and the emissivity value.

In the method according to the first aspect of this invention described above, the temperature of the object body at each picture element of its image is calculated on the basis of the radiant intensity ratio at each pair of corresponding picture elements of the first and second images obtained with the respective radiations of the first and second wavelengths selected from the light emitted from the surface of the object body. On the basis of the thus temperature distribution, the emissivity value at each picture element is calculated according to the predetermined relationship between the temperature and the emissivity of the object body. Thus, the distribution of the surface emissivity of the object body can be accurately measured on the basis of emissivity at each picture element, without using any light source.

In a first preferred form of the method of the present invention, the temperature-distribution measuring step comprises:

a first-wavelength selecting step of selecting the radiation having the first wavelength from the light emitted from the surface of the object body, by using a first filter which permits transmission therethrough a radiation having the first wavelength which is selected according to a radiant-intensity curve corresponding to a wavelength of a black body at a lower limit of a range of the temperature to be measured, and which is within a high radiant intensity range in which the radiant intensity is higher than a radiant intensity at a normal room temperature;

a second-wavelength selecting step of selecting the radiation having the second wavelength from the light emitted from the surface of the object body, by using a second filter which permits transmission therethrough a radiation having the second wavelength which is selected within the high radiant intensity range, such that the second wavelength is different from the first wavelength by a predetermined difference which is not larger than 1/12 of the first wavelength and which is not smaller than a sum of a half width of the first wavelength and a half width of the second wavelength; and

a temperature calculating step of calculating the temperature of the object body at each picture element of its image on the basis of the radiant intensity ratio which is a ratio of the radiant intensity at the first wavelength selected by the first filter to the radiant intensity at the second wavelength selected by the second filter, and according to a predetermined relationship between the radiant intensity ratio and the temperature.

In the first preferred form of the method described above, the distribution of the surface temperature of the object body 12 is obtained on the basis of the temperature at each picture element, which is calculated on the basis of the ratio of the two radiant intensity values and obtained at each pair of corresponding picture elements of the two images of the object body obtained with the respective first and second wavelengths, which are selected by the respective first and second filters in the first-wavelength and second-wavelength selecting steps described above. In the present arrangement, optical signals having sufficiently high radiant intensities can be obtained, leading to an accordingly high S/N ratio of the optical signals. In addition, the first and second wavelengths are close to each other, so that the principle of measurement of the present optical system fully matches the principle of measurement of a dichotic thermometer, namely, fully meets a prerequisite that the dependency of the emissivity on the wavelength can be ignored for two radiations the wavelengths of which are close to each other, leading to approximation ε₁=ε₂. Thus, the present arrangement permits highly accurate measurement of the temperature distribution.

In a second preferred form of the method of this invention, the first filter permits transmission therethrough a radiation having a half width which is not larger than 1/20 of the first wavelength, while the second filter permits transmission therethrough a radiation having a half width which is not larger than 1/20 of the second wavelength. In this form of the method, the radiations having the first and second wavelengths are considered to exhibit a sufficiently high degree of monochromatism. Accordingly, the present arrangement meets the prerequisite for the principle of measurement by a dichroic thermometer, resulting in an improved accuracy of measurement of the temperature distribution.

In a third preferred form of the method of the invention, the first and second filters have transmittance values whose difference is not higher than 30%, so that the present method assures high sensitivity and S/N ratio, even for one of the two radiations of the first and second wavelengths which has a lower luminance value, permitting accurate measurement of the temperature distribution.

In a fourth preferred form of the method of the present invention, the emissivity calculating step comprises; calculating the radiant intensity at the each picture element of the image of the object body on the basis of the temperature at the each picture element calculated in the temperature-distribution measuring step, and according to a predetermined relationship between the radiant intensity and the temperature of the object body; calculating a radiant intensity of a black body at a selected wavelength on the basis of the calculated temperature of the object body, and according to a predetermined relationship between the radiant intensity of the black body and the temperature of the object body; and calculating the emissivity value as a ratio of the calculated radiant intensity of the object body to the calculated radiant intensity of the black body. In this form of the method, the emissivity at each picture element of the image of the object body is calculated as the ratio of the radiant intensity of the object body at the selected wavelength obtained on the basis of the calculated temperature of the object body, to the radiant intensity of the black body at the selected wavelength obtained on the basis of the calculated temperature and according to the predetermined relationship between the temperature of the object body and the radiant intensity of the black body.

The second object indicated above may be achieved according to a second aspect of the present invention, which provides an apparatus for measuring a distribution of emissivity on a surface of an object body, on the basis of a light emitted from the surface of the object body, the apparatus comprising:

a temperature-distribution measuring device operable to calculate a temperature of the object body at each picture element of its image on the basis of a radiant intensity ratio at each pair of corresponding picture elements of a first image and a second image which are obtained with respective two radiations having respective first and second wavelengths selected from the light emitted from the surface of the object body, for thereby measuring a distribution of the temperature on the surface of the object body; and

an emissivity calculating device operable to calculate an emissivity value at each picture element of the image of the object body, on the basis of the distribution of the temperature measured in the temperature-distribution measuring step, and according to a predetermined relationship between the temperature and the emissivity value.

The apparatus according to the second aspect of the invention has substantially the same advantage as described above with respect to the method according to the first aspect of the invention.

In a first preferred form of the apparatus of this invention, the temperature-distribution measuring device comprises:

a first-wavelength selecting device including a first filter operable to select the radiation having the first wavelength from the light emitted from the surface of the object body, the first filter permitting transmission therethrough a radiation having the first wavelength which is selected according to a radiant-intensity curve corresponding to a wavelength of a black body at a lower limit of a range of the temperature to be measured, and which is within a high radiant intensity range in which the radiant intensity is higher than a radiant intensity at a normal room temperature;

a second-wavelength selecting device including a second filter operable to select the radiation having the second wavelength from the light emitted from the surface of the object body, the second filter permitting transmission therethrough a radiation having the second wavelength which is selected within the high radiant intensity range, such that the second wavelength is different from the first wavelength by a predetermined difference which is not larger than 1/12 of the first wavelength and which is not smaller than a sum of a half width of the first wavelength and a half width of the second wavelength; and

a temperature calculating device operable to calculate the temperature of the object body at each picture element of its image on the basis of the radiant intensity ratio which is a ratio of the radiant intensity at the first wavelength selected by the first filter, to the radiant intensity at the second wavelength selected by the second filter, and according to a predetermined relationship between the radiant intensity ratio and the temperature.

The first preferred form of the apparatus described above has substantially the same advantage as described above with respect to the first preferred form of the method.

In a second preferred form of the apparatus, the first filter permits transmission therethrough a radiation having a half width which is not larger than 1/20 of the first wavelength, while the second filter permits transmission therethrough a radiation having a half width which is not larger than 1/20 of the first wavelength. This form of the apparatus has substantially the same advantage as described above with respect to the second preferred form of the method.

In a third preferred form of the apparatus, the first and second filters have transmittance values whose difference is not higher than 30%. This form of the apparatus has substantially the same advantage as described above with respect to the third preferred form of the method.

In a fourth preferred form of the apparatus, the emissivity calculating device comprises; means for calculating the radiant intensity at the each picture element of the image of the object body on the basis of the temperature at the each picture element calculated by the temperature-distribution measuring device, and according to a predetermined relationship between the radiant intensity and the temperature of the object body; means for calculating a radiant intensity of a black body at a selected wavelength on the basis of the calculated temperature of the object body, and according to a predetermined relationship between the radiant intensity of the black body and the temperature of the object body; and means for calculating the emissivity value as a ratio of the calculated radiant intensity of the object body to the calculated radiant intensity of the black body. This form of the apparatus has substantially the same advantage as described above with respect to the fourth preferred form of the method.

### BRIEF DESCRIPTION OF THE DRAWINGS

The above and other objects, features, advantages and technical and industrial significance of the present invention will be better understood by reading the following detailed description of presently preferred embodiment of the invention, when considered in connection with the accompanying drawings, in which:

FIG. 1 is a view schematically illustrating an arrangement of an emissivity-distribution measuring apparatus constructed according to one embodiment of this invention;

FIG. 2 is a view for explaining a manner of determining wavelengths λ₁ and λ₂ of respective first and second filters shown in FIG. 1;

FIG. 3 is a view for explaining first and second images G₁ and G₂ formed on a light detecting surface 26 of an image detector 32 shown in FIG. 1;

FIG. 4 is a flow chart for explaining a relevant part of a control operation performed by an arithmetic control device shown in FIG. 1;

FIG. 5 is a view indicating a relationship used in a picture-element temperature calculating step of FIG. 4, to obtain a surface temperature T from a radiant intensity ratio R;

FIG. 6 is a view indicating a relationship used in a emissivity-distribution displaying step of FIG. 4, to determine a display color from the emissivity ε;

FIG. 7 is a front elevational view of an object body in the form of an alumina substrate used in an experiment in which the emissivity distribution of the substrate was measured by using the apparatus of FIG. 1, wherein hatched areas indicate local surface portions of the alumina substrate which were covered with a baked black paint the emissivity of which is different from the material of the alumina substrate;

FIG. 8 is a view showing an image of the alumina substrate displayed on a displaying device, as a result of the measurement of the surface temperature distribution of the substrate, the image having a uniform color gradation which indicates uniformity in the surface temperature;

FIG. 9 is a view also showing an image of the alumina substrate displayed on the displaying device, wherein the hatched areas indicate a color gradation in the local surface portions of the alumina substrate coated with the baked black paint the emissivity of which is different from the material of the substrate;

FIG. 10 is a view corresponding to that of FIG. 1, illustrating an optical system of an emissivity-distribution measuring apparatus according to another embodiment of this invention;

FIG. 11 is a view corresponding to that of FIG. 1, illustrating an optical system of an emissivity-distribution measuring apparatus according to a further embodiment of this invention; and

FIG. 12 is a view corresponding to that of FIG. 1, illustrating an optical system of an emissivity-distribution measuring apparatus according to a still further embodiment of this invention.

### DETAILED DESCRIPTION OF THE PREFERRED EMBODIMENTS

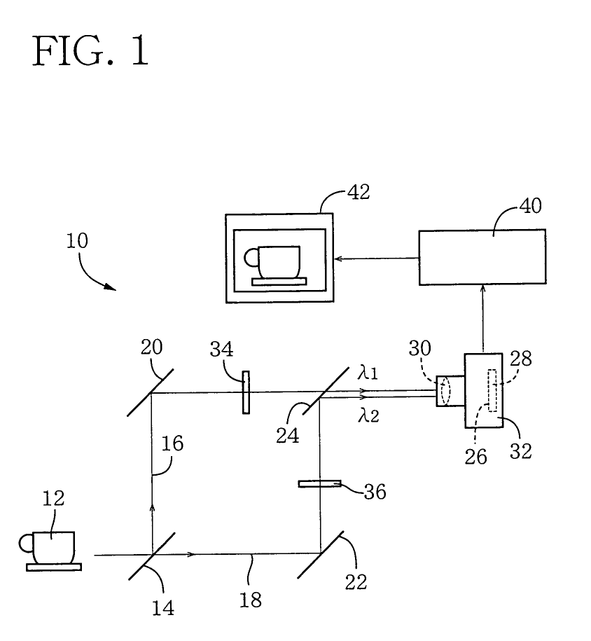

Referring to first to FIG. 1, there is shown an arrangement of an emissivity-distribution measuring apparatus 10 of a first embodiment of this invention, wherein a light emitted from a surface of an object body 12 being heated within a firing furnace or a heating furnace is split by a half mirror (beam splitter) 14 into a first component traveling along a first optical path 16 and a second component traveling along a second optical path 18. The first and second optical paths 16, 18 are bent substantially at right angles by respective mirrors 20, 22, so that the first and second components are both incident upon a half mirror 24, and are respectively transmitted through and reflected by the half mirror 24, so as to be incident upon an image detector 32 which has a CCD device 28 and a lens device 30. The CCD device 28 has a light detecting surface 26 on which are arranged a multiplicity of photosensitive elements. The lens device 30 is arranged to focus images of the object body 12 on the light detecting surface 26.

The first optical path 16 is provided with a first filter 34 which permits transmission therethrough a radiation having a first wavelength (band). λ₁ (e.g., center wavelength of 600 nm) and a half width of about 10 nm, for example. The second optical path 18 is provided with a second filter 36 which permits transmission therethrough a radiation having a second wavelength (band) λ₂ (e.g., center wavelength of 650 nm) and a half width of about 10 nm, for example. The first and second filers 34, 36 are so-called “interference filters” permitting transmission of radiations in selected wavelength bands, utilizing an optical interference.

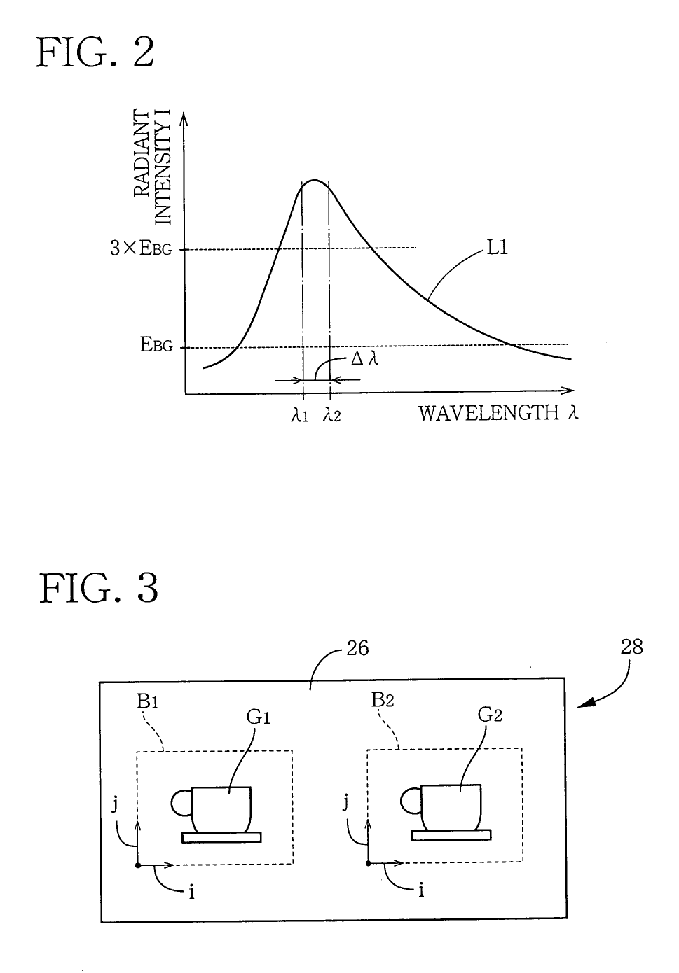

The first and second wavelengths λ₁ and λ₂ are determined in the following manner, for instance. Initially, there is obtained according to the Planck's law a relationship between a wavelength and a radiant intensity of a black body at a lower limit (e.g., 500° C.) of a range of the temperature to be measured. Namely, a curve L1 shown in FIG. 2 is obtained. Then, a background radiant intensity E_{BG} of the object body 12 is measured at a room temperature, for example, at 25° C. Next, the wavelength λ at a desired point which lies on a portion of the curve L1 and which is larger than the background radiant intensity E_{BG} multiplied by three, that is, larger than a value 3×E_{BG} is determined to be the first wavelength λ₁, so that the radiant intensity used for the measurement is high enough to prevent an error of measurement of the temperature. Then, the second wavelength is λ₂ determined to be larger or smaller than the first wavelength λ₁ by a predetermined difference Δλ, which is not larger than 1/12 of the first wavelength λ₁. Where the first wavelength λ₁ is 600 nm, for example, the second wavelength λ₂ is determined to be 650 nm, which is larger than the first wavelength λ₁ by 50 nm. This manner of determination of the first and second wavelengths λ₁ and λ₁ is intended to satisfy an approximating equation 1 which represents the principle of measurement of a dichroic thermometer, and which will be described. It is noted that the difference Δλ between the first and second wavelengths λ₁ and μ₂ must be equal to or larger than a value two times as large as a half width described below, in order to maintain a high degree of accuracy of measurement of the radiant intensity. For the radiations of the first and second radiations λ₁ and λ₂ to maintain properties of a monochromic light, the half widths must be equal to or smaller than 1/20 of the center wavelengths, for example, equal to or smaller than about 20 nm. Further, the first and second filters 34, 36 have transmittance values whose difference is 30% or lower. If the difference were higher than 30%, the sensitivity of one of the two radiations of the first and second wavelengths λ₁λ₂ which has a lower luminance value would be lowered, resulting in a reduced S/N ratio of the image detector 32 and an accordingly reduced accuracy of display of the temperature.

Thus, the emissivity-distribution measuring apparatus 10 according to the present embodiment is arranged to select the two radiations having the respective first and second wavelengths λ₁ and λ₂ from the light emitted from the surface of the object body 12. To this end, the first filter 34 permits transmission therethrough the radiation having the first wavelength λ₁ and the first half width which is not larger than 1/20 of that wavelength. The first wavelength λ₁ is selected according to the radiant-intensity curve L1 corresponding to the wavelength of a black body at the lower limit of the range of the temperature to be measured, and within a high radiant intensity range in which the radiant intensity is sufficiently higher than the background radiant intensity E_{BG} at a normal room temperature. On the other hand, the second filter 26 permits transmission therethrough the radiation having the second wavelength λ₂ and the second half width which is not larger than 1/20 of that second wavelength. The second wavelength λ₂ is selected within the above-indicated high radiant intensity range, such that the second wavelength μ₂ is different from the first wavelength λ₁ by a predetermined difference which is not larger than 1/12 of the first wavelength λ₁ and which is not smaller than a sum of the above-indicated first and second half widths.

In the optical system of FIG. 1, portions of the first and second optical paths 16, 18 between the half mirror 24 and the image detector 32 are spaced from each other by a small distance in a direction parallel to the light detecting surface 26 of the CCD device 28, in order to prevent overlapping of first and second images G₁ and G₂ formed on the light detecting surface 26. This spaced-apart relation of the optical paths 16, 18 is established by suitably orienting the respective mirrors 20, 22, so that the first and second images G₁ and G₂ of respective different wavelengths are formed on the light detecting surface 26 in a spaced-apart relation with each other. Described in detail by reference to FIG. 3, the first image G₁ is formed at a first position B₁ on the light detecting surface 26 of the CCD device 28 of the image detector 32, by the radiation having the first wavelength λ₁ selected by the first filter 34 from the light emitted from the surface of the object body 12, while the second image G₂ is formed at a second position B₂ on the light detecting surface 26, by the radiation having the second wavelength λ₂ selected by the second filter 36 from the light emitted from the surface of the object body 12, such that the first and second positions B₁ and B₂ are spaced apart from each other in the direction parallel to the light detecting surface 26, as indicated in FIG. 3. According to this arrangement, the multiple photosensitive elements arranged on the light detecting surface 26 detect the radiant intensity values at respective picture elements of the first image G₁ and the radiant intensity values at respective picture elements of the second image G₂, such that the picture elements correspond to the respective photosensitive elements. The mirrors 20, 22, half mirrors 14, 24 and lens device 30 cooperate with each other to constitute an optical imaging device capable of performing first and second wavelength-selecting steps of selecting the first and second wavelengths for concurrently forming respective images of the object body 12 at respective positions.

The arithmetic control device 40 is a so-called microcomputer incorporating a central processing unit (CPU), a random-access memory (RAM), a read-only memory (ROM) and an input-output interface. The CPU operates according to a control program stored in the ROM, to process input signals, namely, the output signals of the multiple photosensitive elements arranged on the light detecting surface 26, and control an image display device 42 to display a distribution of the surface temperature of the object body 12.

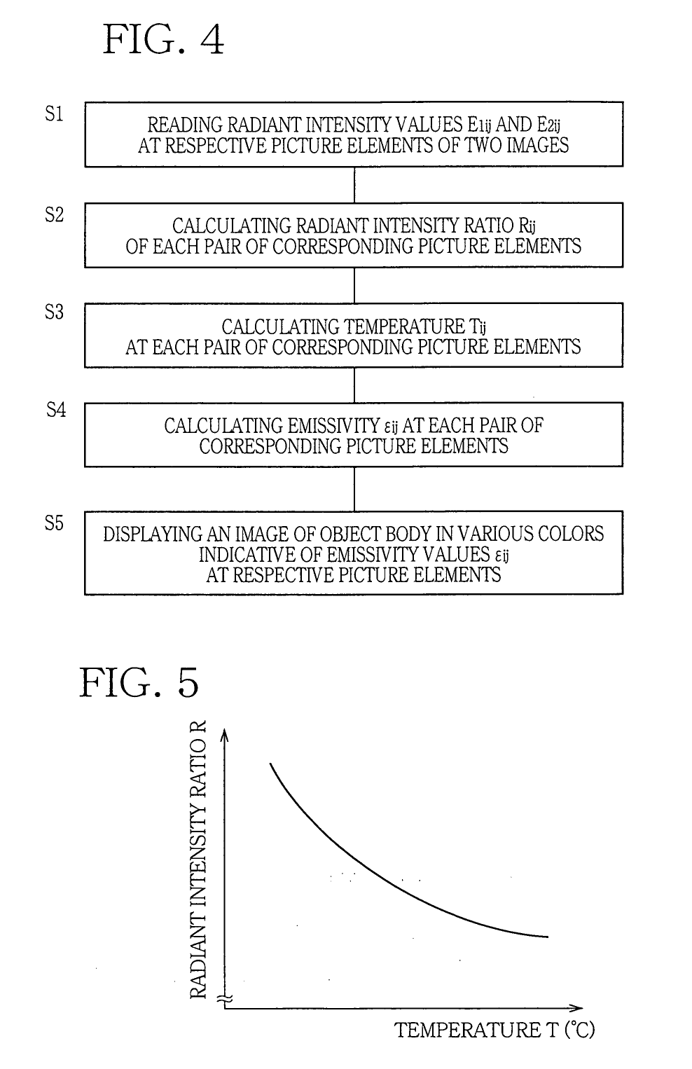

Referring to the flow chart of FIG. 4, there will be described a relevant portion of a control operation of the arithmetic control device 40. The control operation is initiated with step S1 to read the output signals of the multiple photosensitive elements arranged on the light detecting surface 26, for obtaining radiant intensity values E₁ᵢⱼ at respective picture elements of the first image G₁, and radiant intensity values E₂ᵢⱼ at respective picture elements of the second image G₂. Then, the control flow goes to step S2 corresponding to a radiant intensity ratio calculating step or device, to calculate a radiant intensity ratio Rᵢⱼ(=E₁ᵢⱼ/E₂ᵢⱼ) at each pair of corresponding picture elements of the first and second images G₁ and G₂ which are formed at the respective first and second positions B₁ and B₂ on the light detecting surface 26. The radiant intensity ratio Rᵢⱼ is a ratio of the radiant intensity value E₁ᵢⱼ of the first wavelength λ₁ detected by the photosensitive element at each picture element of the first image G₁, to the radiant intensity value E₂ᵢⱼ of the second wavelength λ₂ detected by the photosensitive element at the corresponding picture element of the second image G₂. Then, step S3 corresponding to a picture-element temperature measuring step or device is implemented to calculate a temperature Tᵢⱼ at each picture element of the image of the object body 12, on the basis of the calculated actual radiant intensity ratio Rᵢⱼ at each pair of corresponding picture elements of the first and second images G₁, G₂, and according to a predetermined relationship between the radiant intensity ratio R and the temperature T as shown in FIG. 5, by way of example. Data representative of the predetermined relationship are stored in the ROM. For instance, the relationship as shown in FIG. 5 may be represented by the following equation 1, which is an approximating equation representing the principle of measurement of a dichroic thermometer. The equation 1 is formulated to permit determination of the surface temperature T of the object body 12 on the basis of the ratio R of the radiant intensity values at the respective different wavelengths λ₁ and λ₂, without having to use the emissivity of the object body 12. In the following equations, the second wavelength λ₂ is larger than the first wavelength λ₁, and “T”, “C₁” and “C₂” respectively represent the absolute temperature, and first and second constants of Planck's law of radiation.

R=(λ₂/λ₁)⁵exp[(C₂/T)·(1/λ₂−1/λ₁)] (Equation 1)

The above equation 1 is obtained in the following manner. That is, it is known that an intensity (energy) Eb of a radiation of a wavelength λ emitted from a unit surface area of a blank body for a unit time, and the wavelength λ satisfy the following equation 2, which is the Planck's equation. It is also known that the following equation 3, which is the Wien's approximating equation, is satisfied when exp(C₂/λT)>>1. For ordinary bodies having gray colors, the following equation 4 is obtained by converting the equation 3 with insertion of the emissivity ε. The following equation 5 is obtained from the equation 4, for obtaining the ratio R of the radiant intensity values E₁ and E₂ of the two wavelength values λ₁ and λ₂. Where the two wavelength values λ₁ and λ₂ are close to each other, the dependency of the emissivity ε on the wavelength can be ignored, that is, ε₁=ε₂. Thus, the above equation 1 is obtained. Accordingly, the temperatures T of object bodies having different emissivity values ε can be obtained without an influence of the emissivity.

Eb=C₁/λ⁵[exp(C₂/λT)−1] (Equation 2)

Eb=C₁ exp(−C₂/λT)/λ⁵ (Equation 3)

E=ε·C₁ exp(−C₂/λT)/λ⁵ (Equation 4)

E=(ε₁/ε₂)(λ₂/λ₁)⁵exp[(C₂/T)·(1/λ₂−1/λ₁)] (Equation 5)

After the temperature Tᵢⱼ at each picture element of the image of the object body 12 has been calculated in step S3 as described above, the control flow goes to step S4 corresponding to an emissivity calculating step or device, to calculate the radiant energy intensity value Eᵢⱼ of the object body 12 at a selected wavelength λ, on the basis of the temperature Tᵢⱼ at each picture element calculated in step S3, and according to a predetermined relationship E(T) between the temperature Tᵢⱼ and the radiant energy intensity value Eᵢⱼ of the object body at the selected wavelength λ, which relationship is stored in the ROM of the arithmetic control device 40, and to calculate a radiant energy intensity value Ebᵢⱼ of the black body at the selected wavelength λ on the basis of the temperature Tᵢⱼ at each picture element calculated in step S3, and according to a predetermined relationship (represented by stored data map) between the temperature of the object body and the radiant energy intensity value of the black body. In step S4, the emissivity εᵢⱼ(=Eᵢⱼ/Ebᵢⱼ) at each picture element is calculated as a ratio of the radiant energy intensity value Eᵢⱼ of the object body 12 to the radiant energy intensity value Ebᵢⱼ of the black body.

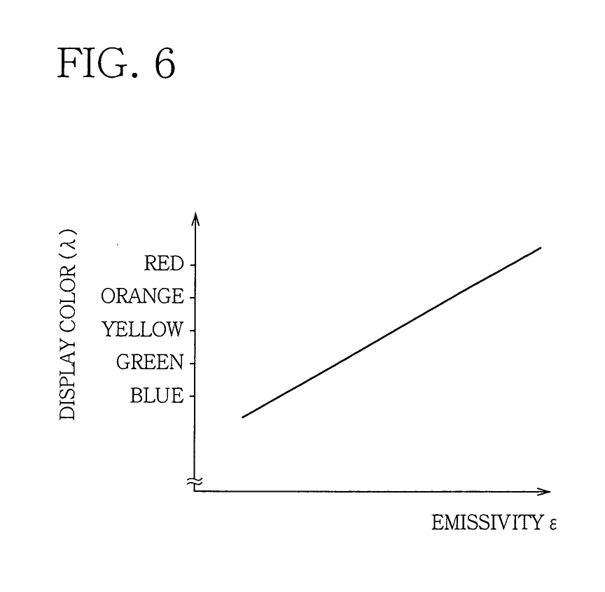

Step S4 is followed by step S5 corresponding to an emissivity-distribution displaying step or device, to display a distribution of the emissivity εᵢⱼ of the object body 12, on the basis of the actual emissivity εᵢⱼ calculated at each picture element, and a predetermined relationship between the emissivity and the display color. Data representative of the predetermined relationship are stored in the ROM. FIG. 6 shows an example of the predetermined relationship between the emissivity ε and the display color. In this case, the distribution of the surface emissivity of the object body 12 is shown in predetermined different colors.

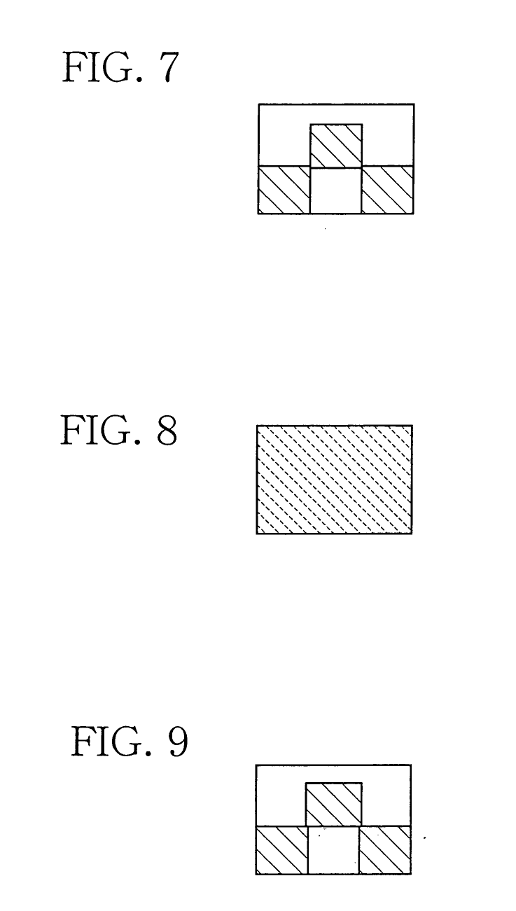

There will be described an experimentation conducted by the present inventors, using the optical system shown in FIG. 1 wherein a CCD camera (model ST-7 available from Santa Barbara Instruments Group) provided with a telephotographic lens “AF Zoom Nikkor ED 7-300 mm F4-5.6D) is employed as the image detector 32, and each of the half mirrors 14, 24 is a half mirror BK7 for a visible radiation, which is available from Sigma Koki, Japan, provided with chrome plating and adapted to reflect 30% of an incident radiation and transmit 30% of the incident radiation. Each of the mirrors 20, 22 is an aluminum plane mirror BK7 which is available from Sigma Koki, Japan. Each of the first and second filers 34, 36 is available from Sigma Koki. The first filter 34 permits transmission therethrough a radiation having a wavelength of 600 nm and a half width of 10 nm, while the second filter 36 permits transmission therethrough a radiation having a wavelength of 650 nm and a half width of 10 nm. The object body 12 which was used in Experiment 1 is an alumina substrate (50 mm×50 mm×0.8 mm) the surface of which is locally covered with a baked black paint whose emissivity is different from that of the alumina substrate, as indicated in FIG. 7. This object body 12 was placed in a central part of a heating furnace, and the temperature within the furnace was raised from the room temperature up to 1000° C. at a rate of 10° C./min. The distribution of the surface temperature of the alumina substrate was measured when the temperature within the furnace reached 950° C. during the rise up to 1000° C. The distribution of the surface emissivity of the alumina substrate was calculated on the basis of the measured distribution of the surface temperature. The experimentation under the conditions described above indicated an even or uniform distribution of the temperature of the alumina substrate over the entire surface, as indicated in FIG. 8, irrespective of the baked black paint which locally covers the surface of the aluminum substrate and which has the emissivity different from that of the aluminum substrate. However, the image displayed in the experimentation indicated higher values of surface emissivity at the local portions covered with the black paint, and a lower value of surface emissivity at the other portions which are not covered with the black paint and which have the exposed alumina surface, as shown in FIG. 9.

In Experiment 2, a stainless steel plate (SUS: 200 mm×200 mm×1 mm) used as the object body 12 was locally heated by a pencil burner which was arranged to generate an oxygen-butane flame. After the local heating for five minutes, the distribution of the surface temperature of the object body 12 was measured, and the distribution of the surface emissivity was calculated, in the same manner as in Experiment 1. While the displayed image indicated a large gradient of the temperature, the distribution of the emissivity could be obtained.

As described above, the present embodiment is arranged to calculate the temperature Tᵢⱼ of the object body 12 at each picture element of its image, on the basis of the radiant intensity ratio Rᵢⱼ at each pair of corresponding picture elements of the first and second images G₁ and G₂ obtained with the respective radiations of the first and second wavelengths λ₁ and λ₂ selected from the light emitted from the surface of the object body 12. On the basis of the thus calculated temperature distribution (temperature Tᵢⱼ at each picture element), the emissivity εᵢⱼ at each picture element is calculated according to the predetermined relationship between the temperature Tᵢⱼ and the emissivity εᵢⱼ. Thus, the distribution of the surface emissivity of the object body 12 can be accurately measured on the basis of emissivity εᵢⱼ at each picture element, without using any light source.

To select the radiation having the first wavelength λ₁ from the light emitted from the surface of the object body 12, the arithmetic control device 40 used in the present embodiment is arranged to implement the first-wavelength selecting step S1, and the optical system uses a first-wavelength selecting device in the form of the first filter 34 which permits transmission therethrough the radiation having the first wavelength λ₁ which is selected according to the radiant-intensity curve L1 corresponding to the wavelength of the black body at the substantially lower limit of the range of the temperature to be measured, and which is within a high radiant intensity range in which the radiant intensity is higher than the background radiant intensity E_{BG} at a normal room temperature. The arithmetic control device 40 is further arranged to implement the second-wavelength selecting step S1, and the optical system further uses a second-wavelength selecting device in the form of the second filter 26 which permits transmission therethrough the radiation having the second wavelength λ₂ which is selected within the above-indicated high radiant intensity range, such that the second wavelength λ₂ is different from the first wavelength λ₁ by a predetermined difference which is not larger than 1/12 of the first wavelength λ₁ and which is not smaller than a sum of a half width Δλ₁ of the first wavelength λ₁ and a half width Δλ₂ of the second wavelength λ₂. The arithmetic control device 40 is further arranged to implement the temperature calculating steps S2 and S3 corresponding to the temperature calculating device, for calculating the surface temperature Tᵢⱼ at each picture element of the object body 12, on the basis of the ratio Rᵢⱼ of the radiant energy intensity value at the first wavelength λ₁ selected by the first filter 34 from the light emitted from the surface of the object body 12, to the radiant energy intensity value at the second wavelength λ₂ selected by the second filter 36 from the above-indicated light, and according to the predetermined relationship between the radiant intensity ratio Rᵢⱼ and the temperature Tᵢⱼ as shown in FIG. 5 by way of example. The distribution of the surface temperature of the object body 12 is obtained on the basis of the temperature Tᵢⱼ at each picture element, which is calculated on the basis of the ratio Rᵢⱼ of the two radiant intensity values E₁ᵢⱼ and E₂ᵢⱼ obtained at each pair of corresponding picture elements of the two images of the object body 12 obtained with the respective first and second wavelengths λ₁ and λ₂ which are selected by the respective first and second filters 34, 36. The steps S1-S3 are considered to be a temperature-distribution measuring step of measuring a distribution of the temperature on the surface of the object body 12. In the present arrangement, optical signals having sufficiently high radiant intensities can be obtained, leading to an accordingly high S/N ratio of the image detector 32. In addition, the first and second wavelengths λ₁ and λ₂ are close to each other, so that the principle of measurement of the present optical system fully matches the principle of measurement of a dichotic thermometer, namely, fully meets a prerequisite that the dependency of the emissivity on the wavelength can be ignored for two radiations the wavelengths of which are close to each other, leading to approximation ε₁=ε₂. Thus, the present measuring apparatus permits highly accurate measurement of the temperature distribution.

In the present embodiment, the arithmetic control device 40 is further arranged to implement the emissivity calculating step S4 corresponding to the emissivity calculating device, for calculating the radiant energy intensity value Eᵢⱼ at the selected wavelength λ at each picture element, on the basis of the temperature Tᵢⱼ of the object body 12 at each picture element calculated in step S3, and according to the stored predetermined relationship between the temperature and the radiant energy intensity value Eᵢⱼ of the object body 12, and further calculating the radiant energy intensity value Ebᵢⱼ of the black body at the wavelength λ on the basis of the temperature Tᵢⱼ at each picture element calculated in step S3, and according to the stored predetermined relationship between the temperature Tᵢⱼ of the object body 12 and the radiant energy intensity value of the black body. The emissivity calculating step or device is arranged to calculate the emissivity εᵢⱼ(=Eᵢⱼ/Ebᵢⱼ) at each picture element, which is the ratio of the radiant energy intensity value Eᵢⱼ of the object body 12 to the radiant energy intensity value Ebᵢⱼ of the black body. Thus, the emissivity εᵢⱼ at each picture element of the image of the object body 12 is calculated as the ratio of the radiant intensity Eᵢⱼ of the object body 12 at the selected wavelength obtained on the basis of the temperature Tᵢⱼ, to the radiant intensity Ebᵢⱼ of the black body at the selected wavelength obtained on the basis of the temperature Tᵢⱼ and according to the predetermined relationship between the temperature Tᵢⱼ of the object body 12 and the radiant intensity Ebᵢⱼ of the black body.

Further, the present embodiment is arranged such that the first filter 34 permits transmission therethrough the radiation having the half width Δλ₁ which is not larger than 1/20 of the first wavelength λ₁, while the second filter 36 permits transmission therethrough the radiation having the half width Δλ₂ which is not larger than 1/20 of the second wavelength λ₂, so that the radiations having these first and second wavelengths λ₁ and λ₂ are considered to exhibit a sufficiently high degree of monochromatism. Accordingly, the present embodiment meets the prerequisite for the principle of measurement by a dichroic thermometer, resulting in an improved accuracy of measurement of the temperature distribution.

In addition, the present embodiment is arranged such that the first and second filters 34, 36 have transmittance values whose difference is not higher than 30%, so that the present optical system has high sensitivity and S/N ratio, even for one of the two radiations of the first and second wavelengths λ₁λ₂ which has a lower luminance value, permitting accurate measurement of the temperature distribution.

While one embodiment of the present invention has been described in detail by reference to the drawings, it is to be understood that the invention may be otherwise embodied.

In the embodiment described above, the temperature distribution of the object body 12 is measured by using the two radiations having the respective two wavelengths and selected from the light emitted from the object body 12, in steps S1-S3. However, the temperature distribution may be measured by using three or more radiations having respective different wavelengths.

In the emissivity calculating step S4 corresponding to the emissivity calculating device, the stored data map representing the predetermined relationship between the temperature and radiant energy intensity of the black body is used to obtain the emissivity Ebᵢⱼ of the black body on the basis of the temperature Tᵢⱼ at each picture element calculated in step S3. However, the stored data map may be replaced by a stored functional equation.

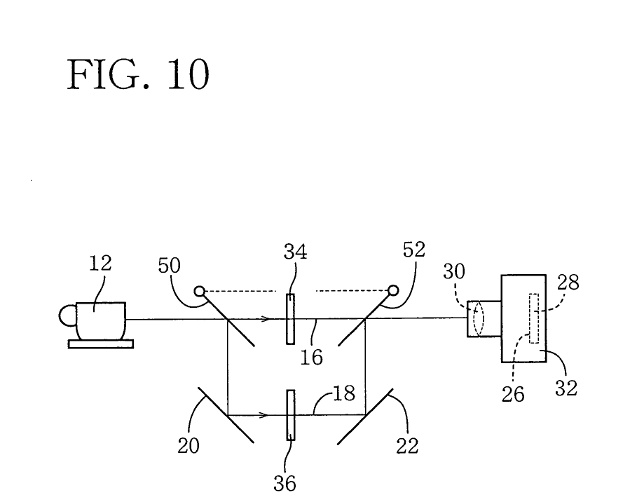

Referring to FIG. 10, there is schematically illustrated an optical system of an emissivity-distribution measuring apparatus according to another embodiment of this invention. In the embodiment of FIG. 10, a pair of mirrors 50, 52 are disposed such that each of these mirrors 50, 52 is pivotable about its fixed end between a first position indicated by broken line and a second position indicated by solid line. When the mirrors 50, 52 are placed in the first position, a light emitted from the surface of the object body 12 is incident upon the image detector 32 along the first optical path 16. When the mirrors 50, 52 are placed in the second position, the light is incident upon the image detector 32 along the second optical path 18. As in the preceding embodiment, the first optical path 16 is provided with the first filter 34, while the second optical path 18 is provided with the second filter 36, so that the first and second images G₁ and G₂ are formed by the respective two radiations having the respective first and second wavelengths λ₁ and λ₂, with a predetermined time difference. Thus, the present embodiment has the same advantage as the preceding embodiment.

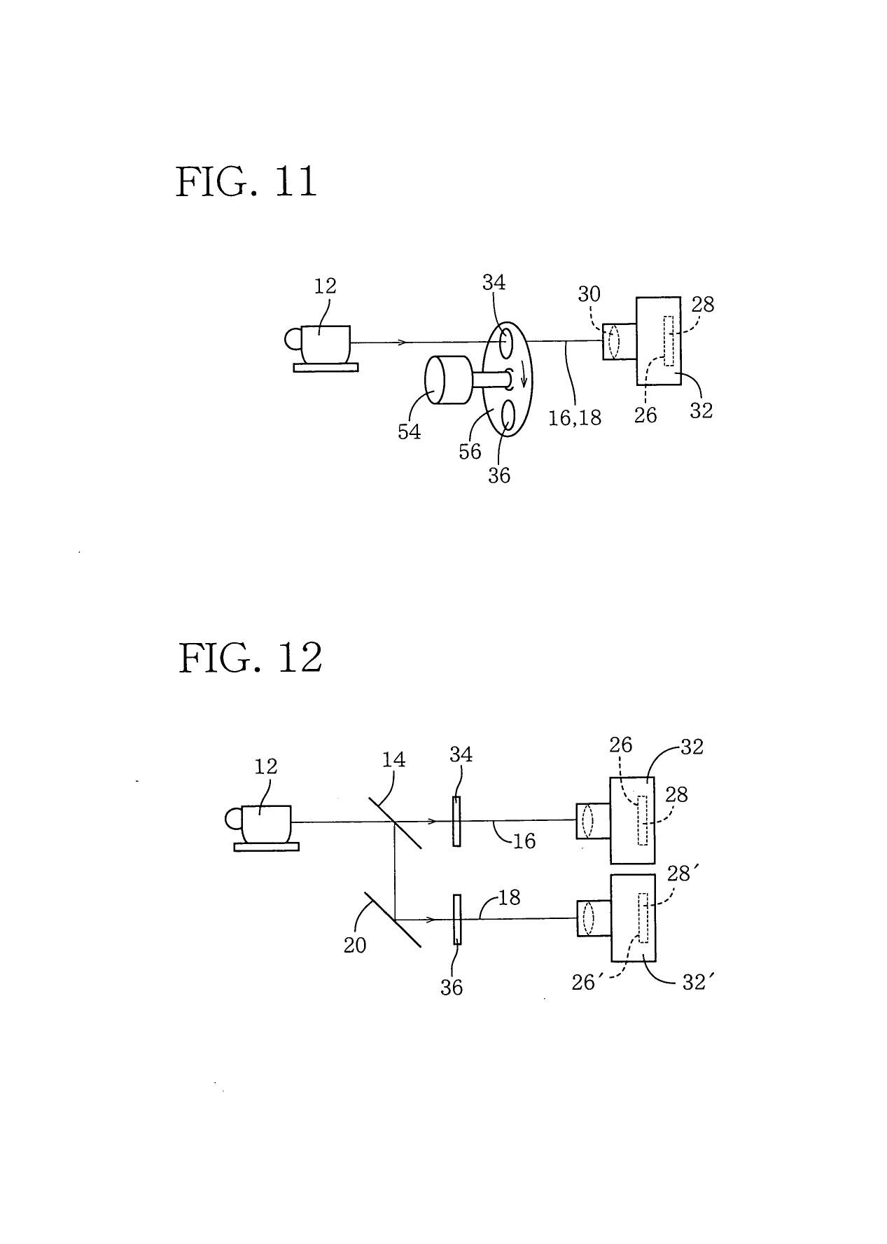

In an embodiment shown in FIG. 11, a rotary disc 56 is disposed such that the rotary disc 56 is rotatable by an electric motor 54, about an axis which is parallel to an optical path extending between the object body 12 and the image detector 32 and which is offset from the optical path in a radial direction of the rotary disc 56, by a suitable distance. The rotary disc 56 carries the first filter 34 and the second filter 36 such that these first and second filters 34, 36 are selectively aligned with the optical path by rotation of the rotary disc 56 by the electric motor 54. The first image G₁ is formed with the radiation which has the first wavelength λ₁ and which has been transmitted through the first filter 34, and the second image G₂ is formed with the radiation which has the second wavelength λ₂ and which has been transmitted through the second filter 36. These first and second images G₁ and G₂ are successively obtained by rotating the rotary disc 56. Thus, the present embodiment has the same advantages as the preceding embodiments. In the present embodiment, the first optical path 16 and the second optical path 18 are considered to be selectively established between the rotary disc 56 and the image detector 32.

In an embodiment of FIG. 12, the light emitted from the surface of the object body 12 is split by the half mirror 14 into a first component traveling along the first optical path 16 and a second component traveling along the second optical path 18. The first optical path 16 is provided with the first filter 34, and the first component which has been transmitted through the first filter34 is incident upon the image detector 32. On the other hand, the second optical path 16 is provided with the second filter 36, and the second component which has been transmitted through the second filter 36 is incident upon another image detector 32′. The first and second filters 34, 36 may be incorporated within the respective image detectors 32, 32′. In the present embodiment, too, the first image G₁ is formed with the radiation having the first wavelength λ₁ which is selected from the light emitted from the surface of the object body 12, as a result of transmission of the light through the first filter 34, and at the same time the second image G₂ is formed with the radiation having the second wavelength λ₂ which is selected from the light from the object body 12 as a result of transmission of the light through the second filter 36.

In the illustrated embodiments, the first and second wavelengths λ₁ and λ₂ are selected according to the radiant-intensity curve L1 of FIG. 2 corresponding to the wavelength of the black body at the lower limit of the range of the temperature to be measured, and which is within a high radiant intensity range in which the radiant intensity is at least three times the background radiant intensity E_{BG} at a normal room temperature. However, the radiant intensity need not be at least three times the background radiant intensity E_{BG}, since the principle of the present invention is satisfied as long as the radiant intensity is sufficiently higher than the background radiant intensity E_{BG} at the normal room temperature.

In the illustrated embodiments, the half width Δλ₁ of the first wavelength λ₁ is equal to or smaller than 1/20 of the first wavelength λ₁, and the half width Δλ₂ of the second wavelength λ₂ is equal to or smaller than 1/20 of the second wavelength λ₂. However, the half widths need not be equal to or smaller than 1/20 of the wavelength values, but may be slightly larger than 1/20 of the wavelength values, according to the principle of the invention.

In the illustrated embodiments, a difference of the transmittance values of the first and second filters 34, 36 is equal to or smaller than 30%. However, the difference need not be equal to or smaller than 30%, but may be slightly larger than 30%, according to the principle of the invention.

Although the surface temperature of the object body 12 is indicated in different colors in step S5 of FIG. 4, the surface temperature may be indicated in any other fashion, for example, by contour lines or in different density values.

While the image detector 32, 32′ used in the illustrated embodiments uses the CCD device 28 having the light detecting surface 26, the image detector may use any other light sensitive element such as a color image tube.

In the illustrated embodiments, the photosensitive elements arranged on the light detecting surface 26 of the CCD device 28 correspond to the respective picture elements of the image of the object body 12. However, the photosensitive elements need not correspond to the respective picture elements. For example, a plurality of photosensitive elements which are adjacent to each other correspond to one picture element of the image.

It is to be understood that the present invention may be embodied with various other changes, modifications and improvements, which may occur to those skilled in the art, in the light of the technical teachings of the present invention which have been described.

What is claimed is:

1. A method of measuring a distribution of emissivity on a surface of an object body, on the basis of a light emitted from said surface of the object body, said method comprising:
a temperature-distribution measuring step of calculating a temperature of said object body at each picture element of its image on the basis of a radiant intensity ratio at each pair of corresponding picture elements of a first image and a second image which are obtained with respective two radiations having respective first and second wavelengths selected from the light emitted from the surface of the object body, for thereby measuring a distribution of the temperature on the surface of the object body; and
an emissivity calculating step of calculating an emissivity value at each picture element of said image of the object body, on the basis of the distribution of the temperature measured in said temperature-distribution measuring step, and according to a predetermined relationship between said temperature and said emissivity value.

2. A method according to claim 1, wherein said temperature-distribution measuring step comprises:
a first-wavelength selecting step of selecting said radiation having said first wavelength from the light emitted from the surface of said object body, by using a first filter which permits transmission therethrough a radiation having said first wavelength which is selected according to a radiant-intensity curve corresponding to a wavelength of a black body at a lower limit of a range of the temperature to be measured, and which is within a high radiant intensity range in which the radiant intensity is higher than a radiant intensity at a normal room temperature;
a second-wavelength selecting step of selecting said radiation having said second wavelength from the light emitted from the surface of said object body, by using a second filter which permits transmission therethrough a radiation having said second wavelength which is selected within said high radiant intensity range, such that said second wavelength is different from said first wavelength by a predetermined difference which is not larger than 1/12 of said first wavelength and which is not smaller than a sum of a half width of said first wavelength and a half width of said second wavelength; and
a temperature calculating step of calculating the temperature of the object body at each picture element of its image on the basis of said radiant intensity ratio which is a ratio of the radiant intensity at said first wavelength selected by said first filter to the radiant intensity at said second wavelength selected by said second filter, and according to a predetermined relationship between said radiant intensity ratio and said temperature.

3. A method according to claim 1, wherein said first filter permits transmission therethrough a radiation having a half width which is not larger than 1/20 of said first wavelength, while said second filter permits transmission therethrough a radiation having a half width which is not larger than 1/20 of said second wavelength.

4. A method according to claim 1, wherein said first and second filters have transmittance values whose difference is not higher than 30%

5. A method according to claim 1, wherein said emissivity calculating step comprises; calculating the radiant intensity at said each picture element of said image of said object body on the basis of the temperature at said each picture element calculated in said temperature-distribution measuring step, and according to a predetermined relationship between said radiant intensity and said temperature of the object body; calculating a radiant intensity of a black body at a selected wavelength on the basis of the calculated temperature of the object body, and according to a predetermined relationship between the radiant intensity of said black body and the temperature of said object body; and calculating said emissivity value as a ratio of the calculated radiant intensity of the object body to the calculated radiant intensity of the black body.

6. An apparatus for measuring a distribution of emissivity on a surface of an object body, on the basis of a light emitted from said surface of the object body, said apparatus comprising:
a temperature-distribution measuring device operable to calculate a temperature of said object body at each picture element of its image on the basis of a radiant intensity ratio at each pair of corresponding picture elements of a first image and a second image which are obtained with respective two radiations having respective first and second wavelengths selected from the light emitted from the surface of the object body, for thereby measuring a distribution of the temperature on the surface of the object body; and
an emissivity calculating device operable to calculate an emissivity value at each picture element of said image of the object body, on the basis of the distribution of the temperature measured ins aid temperature-distribution measuring step, and according to a predetermined relationship between said temperature and said emissivity value.

7. An apparatus according to claim 6, wherein said temperature-distribution measuring device comprises:
a first-wavelength selecting device including a first filter operable to select said radiation having said first wavelength from the light emitted from the surface of said object body, said first filter permitting transmission therethrough a radiation having said first wavelength which is selected according to a radiant-intensity curve corresponding to a wavelength of a black body at a lower limit of a range of the temperature to be measured, and which is within a high radiant intensity range in which the radiant intensity is higher than a radiant intensity at a normal room temperature;
a second-wavelength selecting device including a second filter operable to select said radiation having said second wavelength from the light emitted from the surface of said object body, said second filter permitting transmission therethrough a radiation having said second wavelength which is selected within said high radiant intensity range, such that said second wavelength is different from said first wavelength by a predetermined difference which is not larger than 1/12 of said first wavelength and which is not smaller than a sum of a half width of said first wavelength and a half width of said second wavelength; and
a temperature calculating device operable to calculate the temperature of the object body at each picture element of its image on the basis of said radiant intensity ratio which is a ratio of the radiant intensity at said first wavelength selected by said first filter, to the radiant intensity at said second wavelength selected by said second filter, and according to a predetermined relationship between said radiant intensity ratio and said temperature.

8. An apparatus according to claim 6, wherein said first filter permits transmission therethrough a radiation having a half width which is not larger than 1/20 of said first wavelength, while said second filter permits transmission therethrough a radiation having a half width which is not larger than 1/20 of said first wavelength.

9. An apparatus according to claim 6, wherein said first and second filters have transmittance values whose difference is not higher than 30%.

10. An apparatus according to claim 6, wherein said emissivity calculating device comprises; means for calculating the radiant intensity at said each picture element of said image of said object body on the basis of the temperature at said each picture element calculated by said temperature-distribution measuring device, and according to a predetermined relationship between said radiant intensity and said temperature of the object body; means for calculating a radiant intensity of a black body at a selected wavelength on the basis of the calculated temperature of the object body, and according to a predetermined relationship between the radiant intensity of said black body and the temperature of said object body; and means for calculating said emissivity value as a ratio of the calculated radiant intensity of the object body to the calculated radiant intensity of the black body.

11. An apparatus according to claim 7, further comprising:
a first half mirror for splitting said light emitted from the surface of said object body into two components traveling along respective first and second optical paths which are provided with said first and second filters, respectively;
a second half mirror disposed so as to receive the radiations of said first and second wavelengths from said first and second filters; and
and an image detector including a multiplicity of photosensitive elements operable in response to the radiations of said first and second wavelengths, to form two images of said object body on the basis of said radiations of said first and second wavelengths, respectively, such that said two images are spaced apart from each other.

12. An apparatus according to claim 7, further comprising:
a pair of mirrors each movable between a first position in which the light emitted from the surface of said object body travels along a first path provided with said first filter, and a second position in which a corresponding one of said pair of mirrors reflects said light such that the light travels along a second optical path provided with said second filter; and
an image detector including a multiplicity of photosensitive elements operable in response to the radiations of said first and second wavelengths, to form two images of said object body on the basis of said radiations of said first and second wavelengths, respectively, such that said two images are spaced apart from each other.

13. An apparatus according to claim 7, further comprising:
a rotary disc carrying said first and second filters fixed thereto and rotatable about an axis parallel to an optical path which extends from said object body, said first and second filters being disposed on said rotary disc such that said first and second filters are selectively aligned with said optical path, by rotation of said rotary disc;
an electric motor operable to rotate said rotary disc; and
an image detector including a plurality of photosensitive elements operable in response to the radiations of said first and second wavelengths, to form two images of said object body on the basis of said radiations of said first and second wavelengths, respectively, such that said two images are spaced apart from each other.

14. An apparatus according to claim 6, further comprising:
a half mirror for splitting said light emitted from the surface of said object body into two components traveling along respective first and second optical paths which are provided with said first and second filters, respectively; and
a pair of image detectors disposed to receive the radiations of said first and second wavelengths, respectively, each of said pair of image detectors including a multiplicity of photosensitive elements operable in response to a corresponding one of the radiations of said first and second wavelengths, to an image of said object body on the basis of said corresponding radiation.
